(19) United States
(12) Patent Application Publication
(10) Pub. No.: US 2006/0108396 A1
(43) Pub. Date: May 25, 2006

(54) Bonded components and component bonding

(76) Inventors: Donald O. Nessman, Sierra Madre, CA (US); Franklin G. Monzon, Temple City, CA (US); Peter C. Sercel, Pasadena, CA (US)

Correspondence Address: CHRISTIE, PARKER & HALE, LLP, 350 W. COLORADO BLVD., SUITE 500, PASADENA, CA, 91105, US

(21) Appl. No.: 11/239,658

(22) Filed: Sep. 28, 2005

Related U.S. Application Data
(60) Provisional application No. 60/617,273, filed on Oct. 9, 2004.

(51) Int. Cl. A47J 36/02

(52) U.S. Cl. 228/101

(57) ABSTRACT

A method for bonding first and second components to one another comprises: forming a plurality of bonding area projections on a bonding area of a first component; depositing bonding metal on the bonding area of the first component or a corresponding bonding area of a second component; positioning the first and second components with the deposited bonding metal between their respective bonding areas and in contact therewith; and urging the first and second components toward one another, thereby pressing the deposited bonding metal therebetween. The plurality of bonding area projections protrude into the deposited bonding metal after the bonding metal is pressed between the first and second components. The first and second components are bonded to one another by each adhering to bonding metal. An apparatus comprises first and second components bonded according to the disclosed method.

### BENEFIT CLAIMS TO RELATED APPLICATIONS

This application claims benefit of provisional App. No. 60/617,273 filed Oct. 9, 2004, said provisional application being hereby incorporated by reference as if fully set forth herein.

### BACKGROUND

The field of the present invention relates to optical, electronic, or optoelectronic components. In particular, bonded electronic, optical, or optoelectronic components are described herein, as well as methods for bonding such components.

Numerous examples exist in which an optical, electronic, optoelectronic, or other components are assembled and bonded with the aid of solder or other bonding metal. Such procedures are sometimes referred to as die bonding. In some instances the bonding metal acts only to establish a mechanical bond between the assembled components, while in other instances the bonding metal also serves to establish electrical continuity between the assembled components, through a conductive interconnection pad on the component, for example. Bonding of the assembled components with the bonding metal, whether achieved by reflow of the bonding metal or simply by pressing the components together with the bonding metal therebetween (referred to as tacking), frequently depends on the area of mechanical contact between the bonding metal and the components, and the character of the contact that is achieved.

An example is illustrated in FIGS. 1A-1C. FIG. 1A shows a component 100, with solder or other bonding metal 300 deposited onto a bonding area thereof by any suitable method, and a component 200 to be assembled with component 100. The bonding area of component 100 is shown flush with the rest of the surface of component 100 in FIGS. 1A-1C; it may instead be recessed or raised, as needed or desired. The bonding area of component 100 typically includes (if necessary) an adhesion layer for enabling the deposited bonding metal 300 to adhere to the component 100. For example, a thin layer (a few tens or hundreds of nanometers) of titanium, platinum, or other suitable metal or combination of metals is employed as an adhesion layer on semiconductor components. Any suitable adhesion layer may be employed for a particular component type, if needed or desired. In FIG. 1B, component 200 is positioned with a corresponding bonding area thereof in contact with the bonding metal 300. The bonding area of component 200 is also typically provided (if needed or desired) with an adhesion layer, typically similar to that on component 100. Pressure exerted to urge components 100 and 200 toward one another (typically at an elevated temperature, but still below the reflow temperature of the bonding metal) may be sufficient to bond component 200 to bonding metal 300, thereby also bonding components 100 and 200 to one another. Such “tacking” may be sufficient for assembling components 100 and 200, or it may be the case that the bonding metal must be reflowed (by heating to at least its reflow temperature) in order to achieve the necessary bonding or electrical continuity (as in FIG. 1C). The strength of the bond achieved by tacking may depend on the degree to which the bonding metal surface is disrupted as the components are urged toward one another. The components may be held together or urged toward one another during reflow of the bonding metal, or tacking may be sufficient to hold the components together after initial assembly but prior to reflow. Under some circumstances surface tension of the reflowed bonding metal may draw the assembled components closer together than they were when tacked.

It is sometimes the case that multiple bonding metal joints are required for assembling a given pair of components, for mechanical stability, for providing multiple electrical connections for completing a circuit, or for other reasons. In FIG. 2A, component 100 is shown with two bonding areas with bonding metal 300 deposited thereon. In FIG. 2B, component 200 is shown assembled with component 100 and contacting the bonding metal 300. As already described, tacking may be sufficient for assembling components 100 and 200, or reflow of the bonding metal may be employed (FIG. 2C). However, if the respective thicknesses of the bonding metal 300 on the two bonding areas differ sufficiently, contact between component 200 and both areas of bonding metal 300 may not be achieved, with or without reflow (FIGS. 3A-3C; may depend on the nature of the assembly apparatus and its tendency to allow the components to tilt, or not, during assembly). Although the bonding metal may be somewhat deformed when components 100 and 200 are urged together, the size of the solder layers typically employed (several tens to several hundreds of microns across, and up to about 10 microns thick or more) may not allow sufficient deformation of the first (higher) bonding metal areas to allow the second (lower) bonding metal area to make contact with component 200. Without such contact, no tacking would occur on the second area of bonding metal. Without such contact, no adhesion of the second bonding metal area to component 200 would occur upon reflow.

### SUMMARY

A method for bonding first and second components to one another comprises: forming a plurality of bonding area projections on a bonding area of the first component; depositing bonding metal on the bonding area of the first component or a corresponding bonding area of the second component; positioning the first and second components with the deposited bonding metal between their respective bonding areas and in contact therewith; and urging the first and second components toward one another, thereby pressing the deposited bonding metal therebetween. The plurality of bonding area projections protrude into the deposited bonding metal after the bonding metal is pressed between the first and second components. The first and second components are bonded to one another by each adhering to bonding metal.

Ad apparatus comprises: a first component having a bonding area, the bonding area having a plurality of bonding area projections formed thereon; a second component having a bonding area corresponding to the bonding area of the first component; and bonding metal deposited on the bonding area of the first component or the bonding area of the second component. The first and second components are positioned with the deposited bonding metal between their respective bonding areas and in contact therewith, and with the plurality of bonding area projections protruding into the deposited bonding metal. The first and second components are bonded to one another by each adhering to bonding metal.

Another method for bonding first and second components to one another comprises: depositing bonding metal on a bonding area of the first component; forming a plurality of bonding metal projections on the surface of the deposited bonding metal; positioning the first component and the second component with the deposited bonding metal between respective bonding areas thereof; and urging the first and second components toward one another, thereby pressing the deposited bonding metal therebetween. At least one bonding metal projection is deformed by the bonding metal being pressed between the first and second components. The first and second components are bonded to one another by each adhering to bonding metal. An apparatus may comprise first and second components bonded to one another by this method.

Additional elements and limitations of the methods and apparatus are set forth hereinbelow. Objects and advantages pertaining to bonded components and component bonding may become apparent upon referring to the disclosed embodiments as illustrated in the drawings and disclosed in the following written description or appended claims.

### BRIEF DESCRIPTION OF THE DRAWINGS

FIGS. 1A-1C schematically illustrate assembly of components with bonding metal.

FIGS. 2A-2C schematically illustrate assembly of components with bonding metal.

FIGS. 3A-3C schematically illustrate assembly of components with bonding metal.

FIGS. 4A-4C schematically illustrate assembly of components with bonding metal.

FIGS. 5A-5C schematically illustrate assembly of components with bonding metal.

FIGS. 6A-6C schematically illustrate assembly of components with bonding metal.

FIGS. 7A-7E schematically illustrate various components for assembly with bonding metal.

FIGS. 8A-8D schematically illustrate various components for assembly with bonding metal.

FIGS. 9A-9C schematically illustrate various components for assembly with bonding metal.

FIGS. 10A-10D schematically illustrate assembly of components with bonding metal.

FIGS. 11A-11B schematically illustrate components assembled with bonding metal.

FIGS. 12A-12D schematically illustrate components assembled with bonding metal.

FIGS. 13A-13D schematically illustrate components assembled with bonding metal.

FIGS. 14A-14B schematically illustrate bonding area projections on a component.

The embodiments shown in the Figures are exemplary, and should not be construed as limiting the scope of the present disclosure and/or appended claims.

### DETAILED DESCRIPTION OF EMBODIMENTS

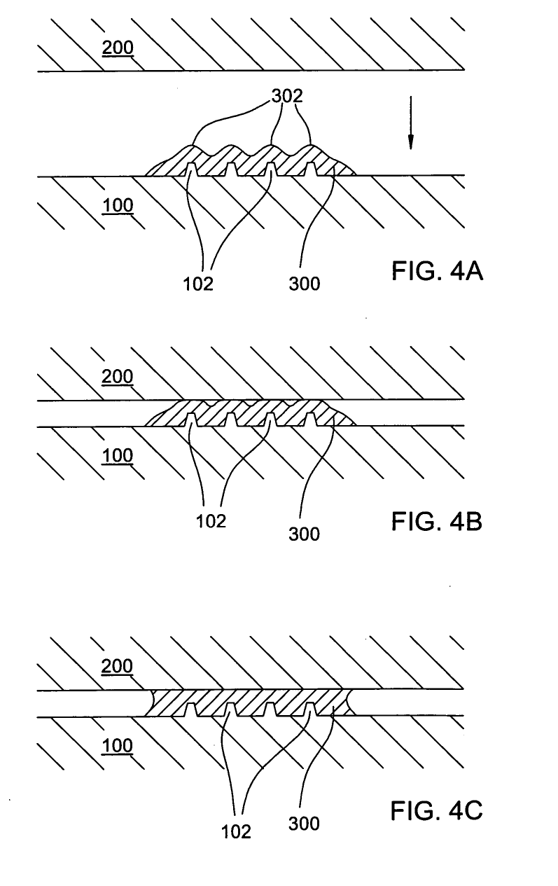

FIGS. 4A-4C illustrate schematically the assembly of components 100 and 200 with bonding metal 300. The bonding metal may comprise any suitable metal, solder, or alloy. Examples include but are not limited to: gold, platinum, copper, aluminum, palladium, solder (such as gold/tin solder, lead/tin solder, and so forth), other metals or alloys, or combinations thereof. Component 100 has a plurality of bonding area projections 102 formed on a bonding area thereof (FIG. 4A). An adhesion layer (if needed or desired; typically a thin layer of titanium, platinum, or other suitable metal or combination of metals; not explicitly shown in the Figures) may typically be deposited on the bonding area and the projections thereof for enabling the bonding metal 300 to adhere to the bonding area of component 100. A corresponding bonding area of component 200 may also include such an adhesion layer. Bonding metal 300 is deposited on the bonding area of component 100 over the bonding area projections 102, resulting in a plurality of bonding metal projections 302 protruding from the surface of the deposited bonding metal 300 (FIG. 4A). The bonding metal projections 302 are formed above the bonding area projections 102 upon deposition of the bonding metal. 300 over the bonding area, and bonding area projections 102 protrude into bonding metal 300. The components 100 and 200 are positioned with the deposited bonding metal between their respective bonding areas and with one or more of the bonding metal projections 302 on the surface of bonding metal 300 in contact with the bonding area of component 200. The components 100 and 200 are urged toward one another, thereby pressing the bonding metal 300 therebetween (FIG. 4B). Bonding metal projections 302 that contact the component 200 may be deformed as the bonding metal 300 is pressed between the components. The small area of bonding metal projections 302, relative to the total area of bonding metal 300, typically enables a larger amount of additional movement of the components toward each other after contact is made than is typically possible without the bonding metal projections. As the components 100 and 200 are further urged toward one another and the initially contacted bonding metal projections 302 are thereby deformed, additional bonding metal projections 302, that may not have contacted component 200 initially, may come into contact with component 200 and may also become deformed. Bonding area projections 102 remain protruding into bonding metal 300.

The deformation of bonding metal projections 302 may result in sufficient bonding between bonding metal 300 and component 200 that they remain bonded or attached to one another even after removing the force urging the components toward one another (i.e., the components 100 and 200 remain “tacked”, as in FIG. 4B). Such tacking may be achieved at an elevated temperature, but still below the reflow temperature of the bonding metal. The mechanical strength of such tacking may be sufficient for final assembly of components 100 and 200. Alternatively, bonding metal 300 may be reflowed (by heating it to at least its reflow temperature) to establish or increase bonding between the bonding metal 300 and the components 100 or 200 and effecting final assembly of components 100 and 200 (as in FIG. 4C). Bonding area projections 102 typically remain protruding into bonding metal 300 after reflow. It may be necessary to hold the components in place or urge them toward each other during reflow, or tacking resulting from the initial pressing of the bonding metal between the components may be sufficient to keep the components suitably positioned during reflow. Surface tension or flow of bonding metal may result in relative movement of the components during reflow if they are not held in place. Such movement may be expected or desired, may constrained by mechanical features of one or both components (if needed or desired), or may be one contribution to the relative positional tolerance of the assembled components.

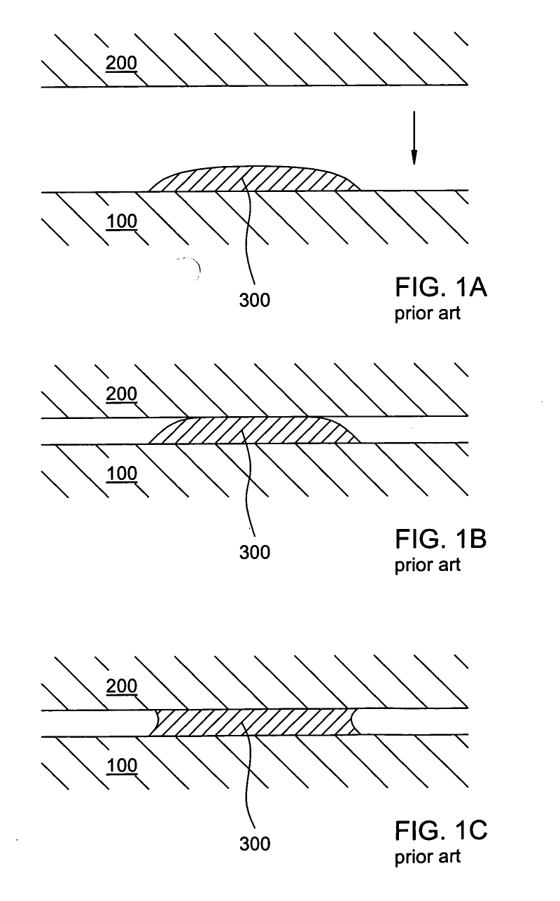

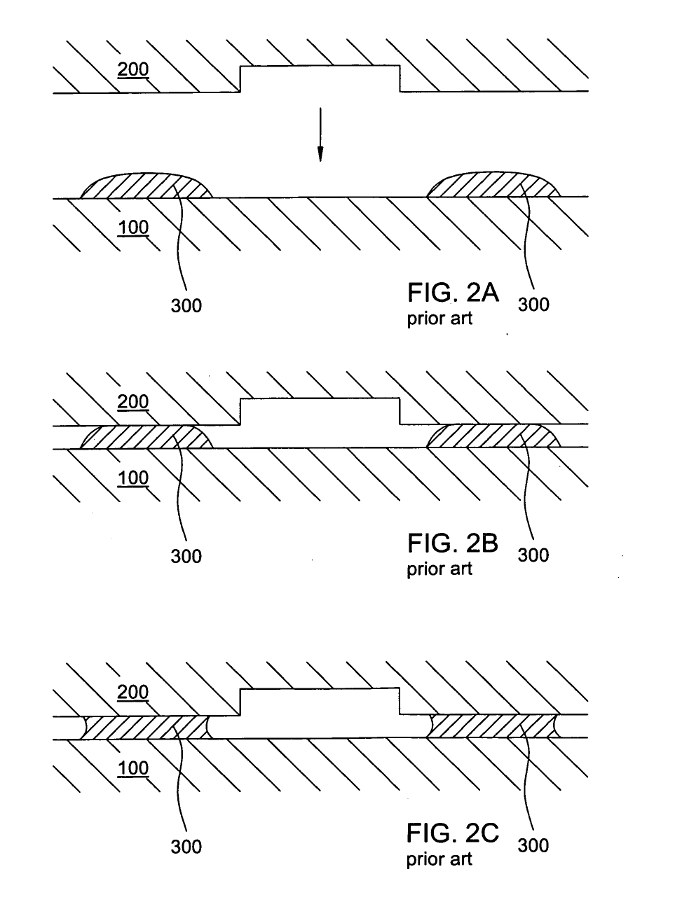

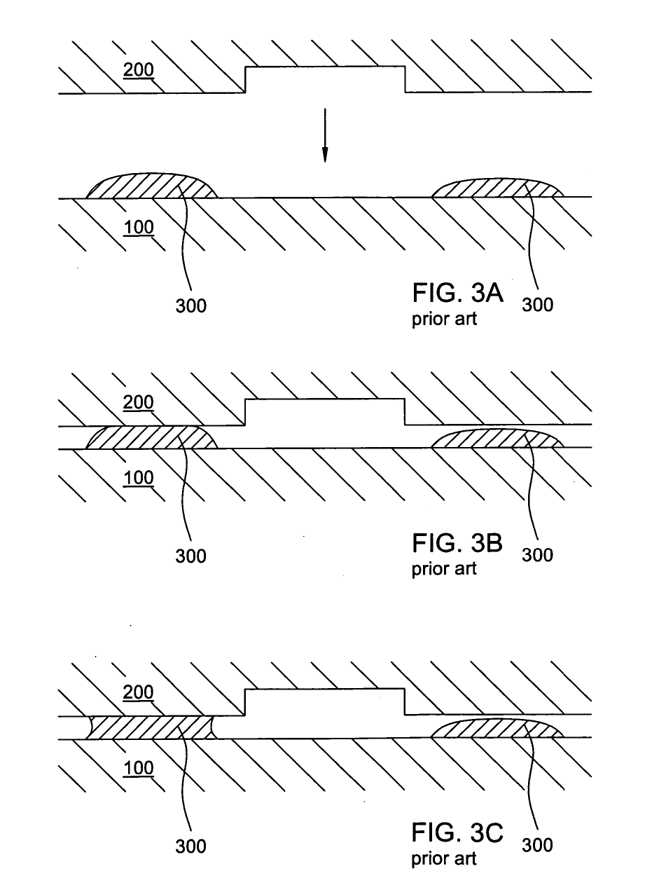

It has been observed that adhesion between bonding metal 300 and component 200, when configured with bonding area projections 102 and bonding metal projections 302 and then tacked (as in FIGS. 4A-4B), may exceed the adhesion between the bonding metal and component when configured and tacked as in FIGS. 1A-1B. The tack strength achieved with the projections 102 and 302 may in some cases be two or more times greater than the tack strength achieved without such projections. The yield of components properly bonded is also typically increased by the presence of projections 102 and 302. If the bonding metal is reflowed, the difference in mechanical strength may not be so pronounced. However, similar improvements in yield of properly bonded components are typically observed. It has been observed that adhesion of reflowed bonding metal 300 to components 100 and 200 may be achieved without use of flux or wetting agent. It may be the case that disruption of the surface of bonding metal 300, by deformation of bonding metal projections 302, enables the reflowed bonding metal to wet component 200 and adhere thereto without the aid of flux. It has been observed that the accuracy of alignment of bonded parts may in some circumstances be improved (whether tacked or reflowed) by presence of bonding metal projections 302.

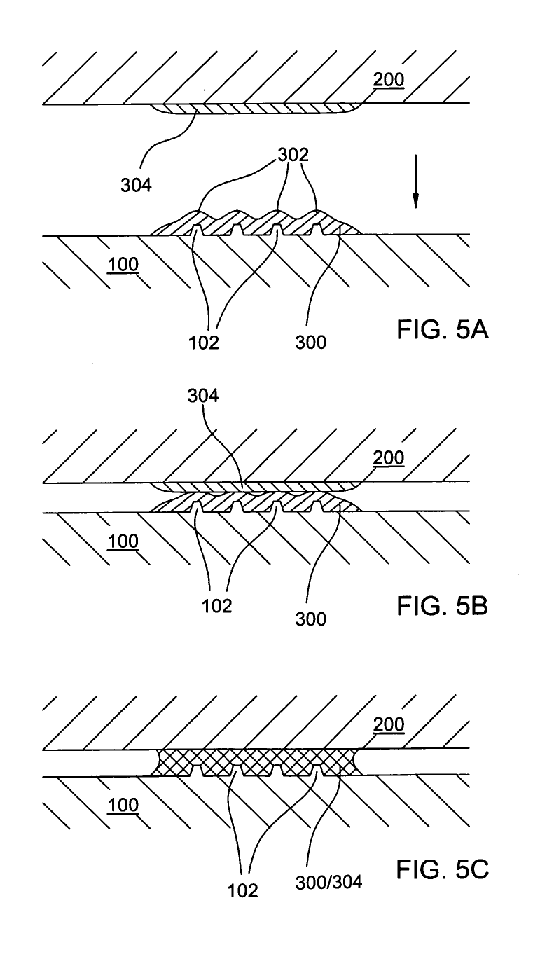

A variation on the arrangement and procedure illustrated in FIGS. 4A-4C is illustrated schematically in FIGS. 5A-5C. Component 100 again has a plurality of bonding area projections 102, and bonding metal 300 deposited over the projections 102 results in bonding metal projections 302. Bonding metal 304 is deposited over a bonding area of component 200. As the components 100 and 200 are positioned and urged toward one another, the bonding metal projections 302 make contact with bonding metal 304, instead of directly contacting component 200. Pressing the bonding metal 300 and 304 between the components 100 and 200 may deform one or more bonding metal projections 302. The components may be bonded or attached to one another by tacking (FIG. 5B) or reflow (FIG. 5C), according to the description already given hereinabove.

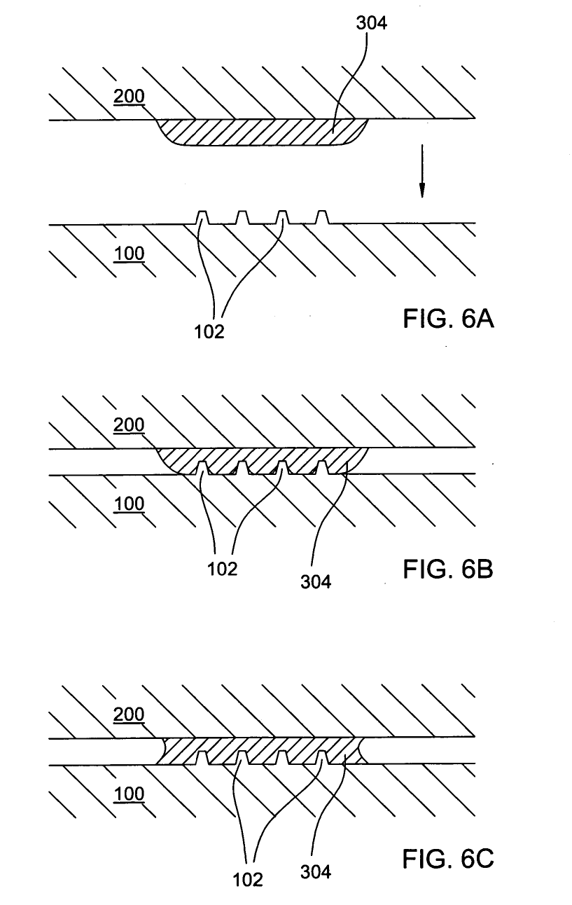

Another variation on the arrangement and procedure illustrated in FIG. 4A-4C is illustrated schematically in FIG. 6A-6C. A plurality of bonding area projections 102 is formed on a bonding area of component 100, but no bonding metal is deposited thereon. Bonding metal 304 is deposited on a bonding area of component 200 (FIG. 6A). The components 100 and 200 are positioned with bonding metal 304 between their respective bonding areas and are urged toward one another, pressing the bonding metal therebetween. As a result, bonding area projections 102 protrude into bonding metal 304 after the bonding metal is pressed between the components (FIG. 6B). Material forming projections 102 must be sufficiently harder than bonding metal 304 to enable the projections 102 to protrude into bonding metal 304 as the components are urged toward one another. Surface irregularities or non-uniformities may cause one or more of projections 102 to make contact with bonding metal 304 before the others, but the relatively small area of the projections 102 (relative to the area of bonding metal 304) typically enables continued movement of the components toward each other, and contact of additional projections 102 with the bonding metal 304. Disruption of the surface of bonding metal 304 and protrusion of at least some of projections 102 into bonding metal 304 may serve to tack the components together. As described hereinabove, such tacking may be sufficient for final assembly of the components, or reflow of the bonding metal may be required. Contact between projections 102 and bonding metal 304 serves to facilitate reflow of bonding metal 304 from component 200 onto component 100 (FIG. 6C), and bonding area projections 102 typically remain protruding into the bonding metal 304 after reflow.

Any suitable material processing technique or combination of techniques may be employed for forming components 100 and 200, bonding areas thereon, bonding area projections 102, or for depositing bonding metal 300 or 304. The procedures and structures disclosed herein may find particular utility when used to bond components ranging in size from a few tens of microns across up to a few millimeters across or even larger (“across” here referring to dimensions substantially parallel to the bonded surfaces of the components, i.e. length or width). Such devices may include bonding areas a few tens of microns across up to a few hundred microns across or even larger. Bonding metal deposited on such bonding areas may typically be a few microns deep up to ten or more microns deep, with depth variations on the order of a few tens up to several hundreds of nanometers or more arising from typical deposition processes. For such size ranges, bonding area projections 102 between about 3 μm across and about 20 μm across (average width) may be suitable, or between about 6 μm across and about 15 μm across. The bonding area projections may be between about 1 μm high and about 20 μm high, or between about 2 μm high and about 10 μm high, and it may be desirable that the height of the bonding area projections not exceed the depth of the bonding metal 300 or 304. The bonding area projections 102 may have any suitable cross-sectional shape, including but not limited to circular (FIG. 14B), oval, elliptical, square (FIG. 14A), line segments, a grid, rectangular, regular or irregular polygonal, and so forth, and in many instances may be chosen based on convenience of fabrication. The plurality of bonding area projections 102 may be arranged in any suitable way on the bonding area, including but not limited to a line, a circle or ring (FIG. 14B), a rectangular or other array (FIG. 14A), or any other suitable or convenient arrangement. It may be desirable to space apart the bonding area projections 102 by at least their cross-sectional size to allow for deformation of the corresponding bonding metal projections 302 upon assembly, or smaller or larger spacings may be employed if needed, desired, suitable, or convenient.

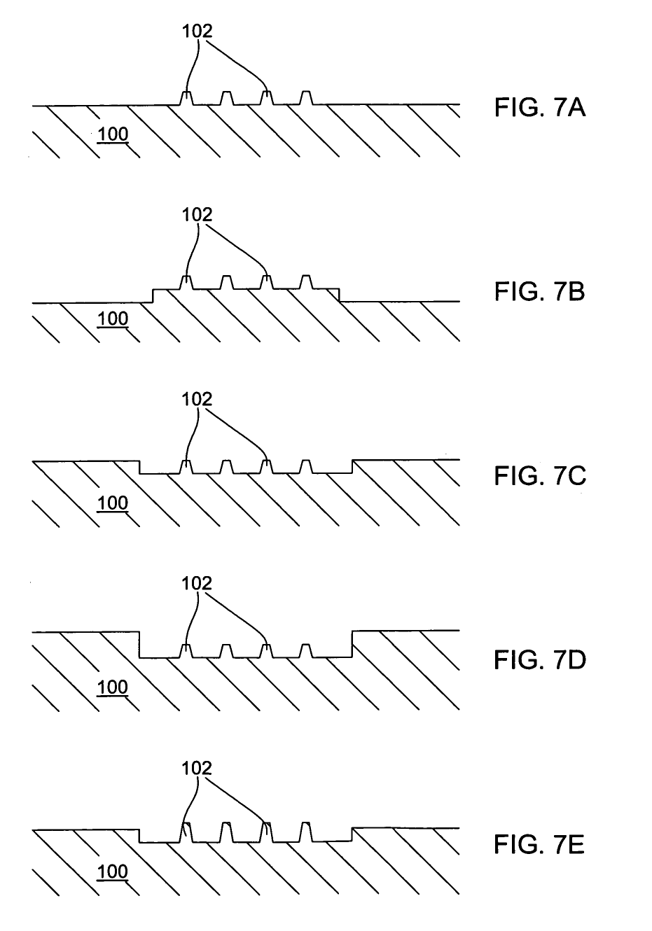

Any of a wide variety of material processing techniques may be employed for forming bonding area projections 102 on a bonding area of component 100, and the choice and implementation of a particular technique or combination of techniques typically determine the vertical shape of the bonding area projections 102 and the bonding area on component 100. Various lithographic techniques may be suitable for forming bonding area projections 102 and the bonding area, particularly since it is often the case that such techniques are employed to form the component 100 itself. It may therefore be the case that the processing sequence for forming component 100 may be readily modified, adapted, or added to for also forming bonding area projections 102. Alternatively, bonding area projections 102 may be formed by a wholly separate process or sequence. The bonding area may be formed in any needed or desired arrangement, including flush with the surface of component 100 (FIG. 7A), raised above the surrounding surface of component 100 (FIG. 7B), or recessed below the level of the surrounding surface of component 100 (FIGS. 7C-7E). If recessed, the bonding area projections 102 may be flush with the surrounding surface of the component 100 (FIG. 7C), may extend above the surrounding surface (FIG. 7D), or may be recessed from the surrounding surface (FIG. 7E).

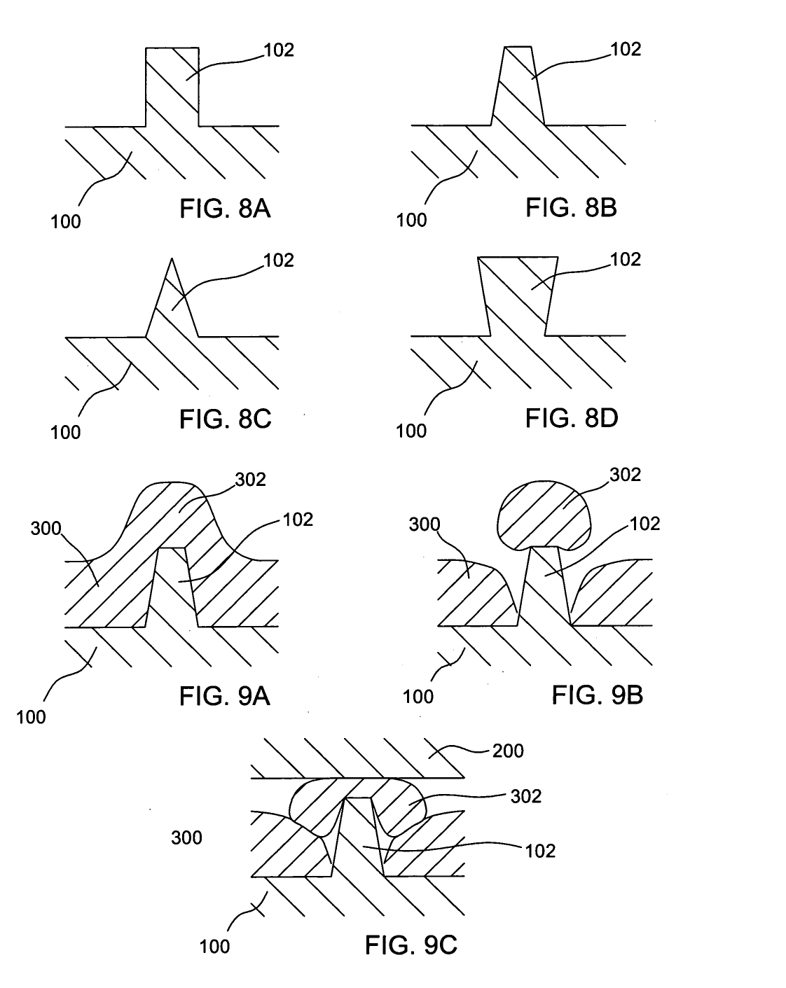

Depending on the materials and material processing steps employed, the bonding area projections 102 may have substantially vertical sides and a substantially flat top (FIG. 8A), may be undercut (FIG. 8D), or may taper (FIGS. 8B and 8C). A tapered bonding area projection 102 may have a substantially flat top (FIG. 8B) or may come to a sharp or rounded top (FIG. 8C). Excessive undercutting may mechanically weaken the projection, which may or may not be relevant, depending on the subsequent assembly steps. A taper may facilitate penetration of bonding metal by the projection (as in FIG. 6B, for example). A substantially flat top may facilitate formation of solder projections 302 (as in FIGS. 4A-4C, for example). The deposition process for depositing bonding metal 300 may be somewhat conformal, which may yield substantially complete coverage of the bonding area projection 102 by bonding metal projection 302 (FIG. 9A). Other deposition processes may yield overhanging bonding metal projections 302, which in turn mask underlying portions of the bonding area (FIG. 9B) and may perhaps result in a lack of continuity between bonding metal 300 and the projection 302 thereof (FIG. 9B). However, deformation of the bonding metal projection 302 upon assembly may establish such continuity (as in FIG. 9C), if not already present. Silicon or other semiconductor materials may frequently be employed for forming at least a portion of component 100 or 200, and any of the myriad material processing techniques developed for processing of such materials, including lithographic techniques, may be employed for forming the projections 102.

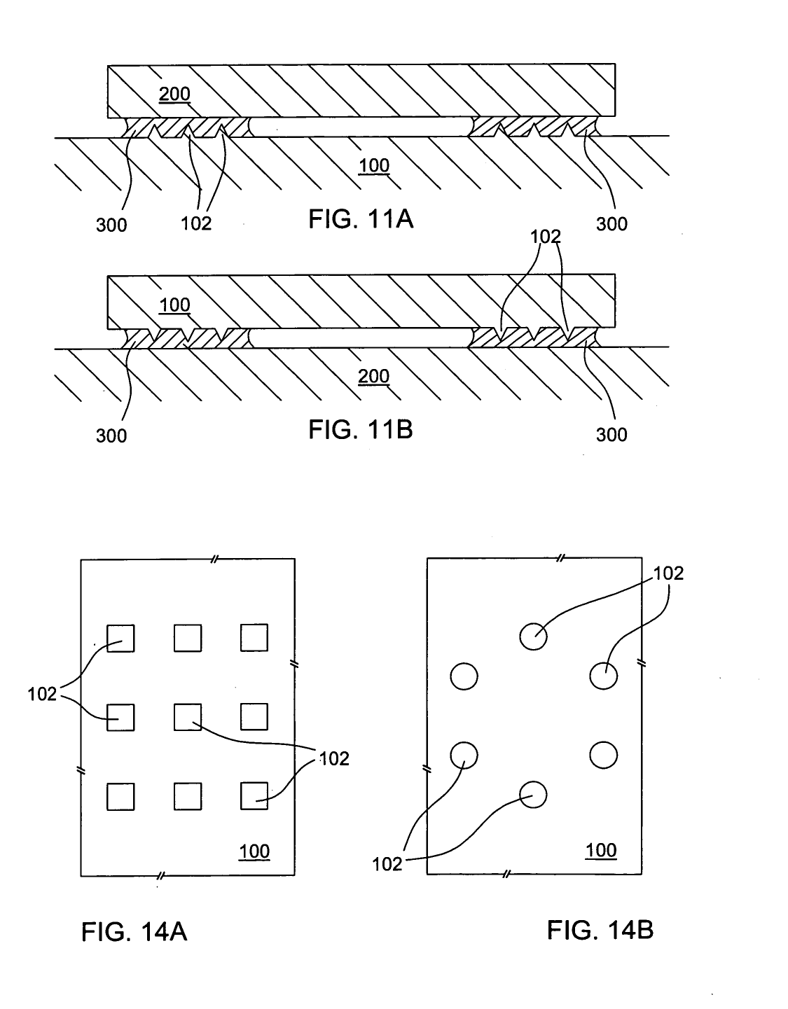

The methods and structures disclosed herein may be employed for bonding any desired components, and may be particularly suited for bonding electronic, optical, or optoelectronic components (FIGS. 11A-11B). Such components may include, but are not limited to, planar optical waveguides, planar optical waveguide substrates, photodetectors, optical filters, lasers, optical modulators, optical amplifiers, optical reflectors, optical isolators, lenses, other optical or optoelectronic components, transistors, resistors, capacitors, inductors, electronic amplifiers, integrated circuits, other electrical or electronic components, brackets, retainers, other mechanical components, combinations thereof, or functional equivalents thereof. If the bonding metal is to provide both mechanical bonding and electrical continuity between components, then the respective bonding areas of the components 100 and 200 will each typically include a conductive interconnection pad thereon. If metal adhesion layers are employed, they may typically also serve as conductive interconnection pads.

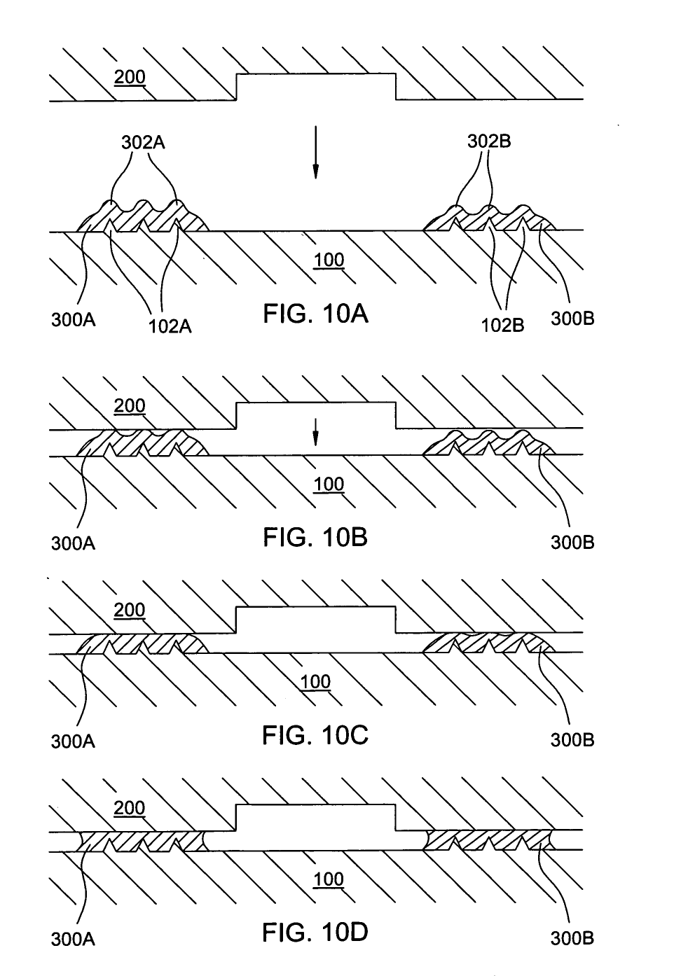

In many instances where electrical contact is established, two or more separate contacts are required, thereby requiring two or more corresponding separate bonding joints (as in FIGS. 11A-11B, for example). The use of bonding area projections on the bonding areas of at least one of the components may increase the yield of assembled components with two or more properly bonded contacts (FIGS. 10A-10D). FIG. 10A schematically illustrates a component 100 with sets of bonding area projections 102A and 102B formed on two separate bonding areas. Bonding metal 300A/300B is deposited over the two sets of bonding area projections 102A/102B, respectively, thereby forming respective sets of bonding metal projections 320A/302B. Component 200 is positioned and urged toward component 100 with bonding metal 302A/302B between the respective bonding areas of the components (FIGS. 10B-10C). If the bonding metal projections 302A/302B are of sufficiently uniform height, bonding metal projections in both bonding areas may make contact with component 200, and may become deformed as the bonding metal is pressed between components 100 and 200 (FIG. 1C). However, if the heights of the bonding metal projections 302A and 302B differ sufficiently (as may frequently be the case given the inherent uncertainties of typical deposition processes), one or more of bonding metal projections 302A may contact component 200 before any of bonding metal projections 302B make contact (FIG. 10B). However, the small areas of the bonding metal projections 302A, relative to the total area of the bonding areas, enable continued movement of components 100 and 200 toward one another with deformation of bonding metal projections 302A, until contact between component 200 and bonding metal projections 302B is achieved (FIG. 10C). As described hereinabove, final assembly of components 100 and 200 may be effected by tacking (FIG. 10C) or by reflow of bonding metal 300A and 300B (FIG. 10D).

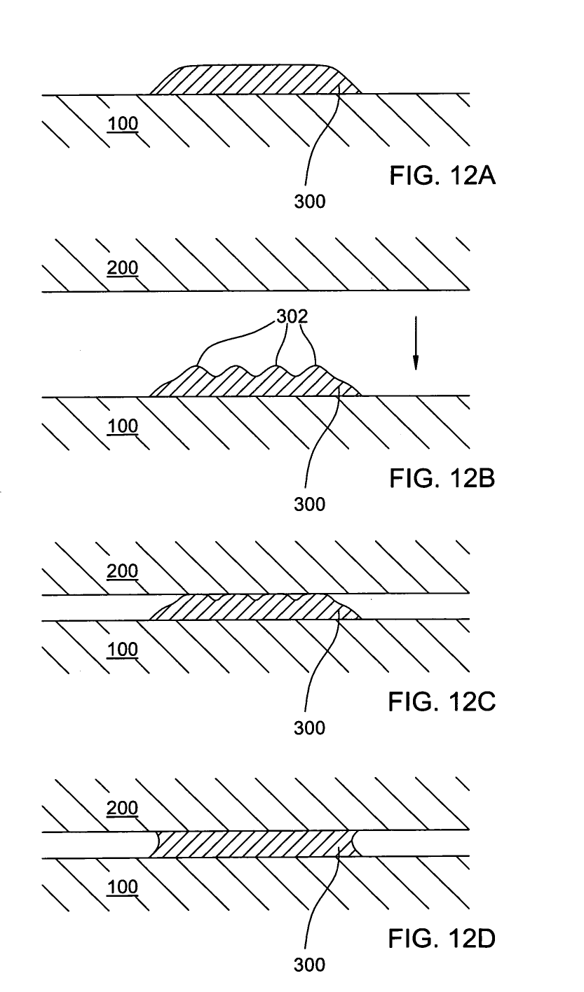

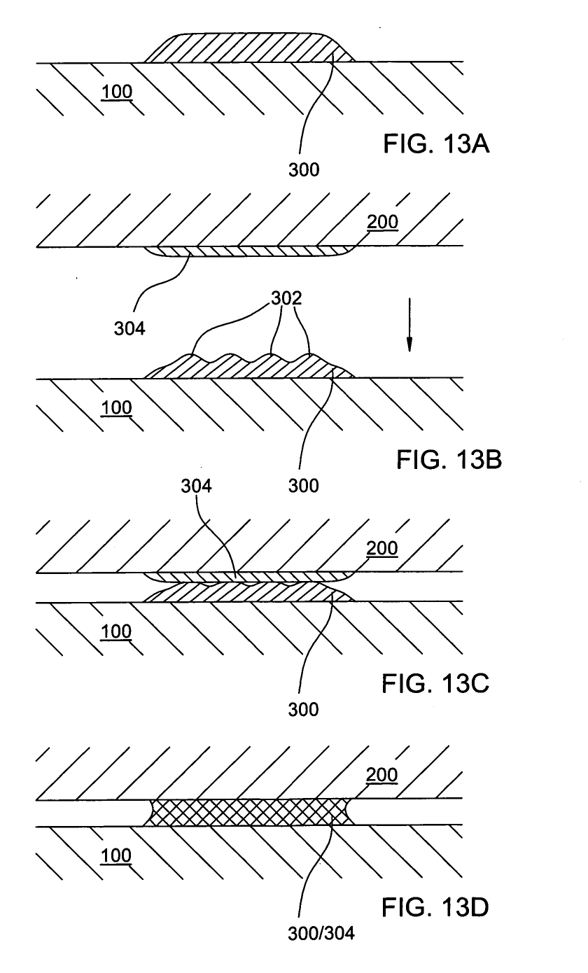

Bonding between components similar to that illustrated in FIGS. 4A-4C and 5A-5C may be achieved without the presence of bonding area projections 102. Such alternative bonding is illustrated in FIGS. 12A-12D (analogous to FIGS. 4A-4C) and 13A-13D (analogous to FIGS. 5A-5C). In these embodiments, bonding metal 300 is deposited on the bonding area of component 100 (FIGS. 12A and 13A), which lacks any bonding area projections. Subsequent spatially-selective material processing steps are employed to yield bonding metal projections 302 on the surface of bonding metal 300 (FIGS. 12B and 13B). Further assembly and bonding proceed as described earlier for FIGS. 4A-4C and FIGS. 5A-5C, with the components urged toward one another and bonded by tacking (FIGS. 12C and 13C) or by reflow of the bonding metal (FIGS. 12D and 13D).

For purposes of the present disclosure and appended claims, the conjunction “or” is to be construed inclusively (e.g., “a dog or a cat” would be interpreted as “a dog, or a cat, or both”), unless: i) it is explicitly stated otherwise, e.g., by use of “either . . . or”, “only one of”, or similar language; or ii) two or more of the listed alternatives are mutually exclusive within the particular context, in which case “or” would encompass only those combinations involving non-mutually-exclusive alternatives. It is intended that equivalents of the disclosed exemplary embodiments and methods shall fall within the scope of the present disclosure or appended claims. It is intended that the disclosed exemplary embodiments and methods, and equivalents thereof, may be modified while remaining within the scope of the present disclosure or appended claims.

What is claimed is:

1. A method for bonding first and second components to one another, comprising:
forming a plurality of bonding area projections on a bonding area of the first component;
depositing bonding metal on the bonding area of the first component or on a corresponding bonding area of the second component;
positioning the first and second components with the deposited bonding metal between their respective bonding areas and in contact therewith; and
urging the first and second components toward one another, thereby pressing the deposited bonding metal therebetween,
wherein:
the plurality of bonding area projections protrude into the deposited bonding metal after the bonding metal is pressed between the first and second components; and
the first and second components are bonded to one another by each adhering to bonding metal.

2. The method of claim 1, wherein the respective bonding areas of the first and second components comprise conductive interconnection pads.

3. The method of claim 1, wherein:
the bonding metal is deposited on the bonding area of the first component after the plurality of bonding area projections is formed;
the plurality of bonding area projections protrude into the deposited bonding metal before the bonding metal is pressed between the first and second components; and
depositing the bonding metal on the bonding area of the first component results in a plurality of bonding metal projections protruding from the surface of the deposited bonding metal, the bonding metal projections being formed above the plurality of bonding area projections upon deposition of the bonding metal thereon.

4. The method of claim 3, wherein at least one bonding metal projection makes contact, when the bonding metal is pressed between the first and second components, with the bonding area of the second component, and the bonding metal projection thus contacted is deformed by the bonding metal being pressed between the first and second components.

5. The method of claim 3, wherein:
bonding metal is also deposited on the bonding area of the second component; and
at least one bonding metal projection makes contact, when the bonding metal is pressed between the first and second components, with the bonding metal deposited on the bonding area of the second component, and the bonding metal projection thus contacted is deformed by the bonding metal being pressed between the first and second components.

6. The method of claim 1, wherein the bonding metal is deposited on the bonding area of the second component, and the bonding area projections protrude into the bonding metal deposited on the bonding area of the second component after the bonding metal is pressed between the first and second components.

7. The method of claim 1, wherein the first and second components are urged toward one another with sufficient force so that upon release of the urging force the first and second components remain attached to one another by adhering to the deposited bonding metal without reflow of the bonding metal.

8. The method of claim 1, further comprising heating the bonding metal so that it reflows, wherein the plurality of bonding area projections continue to protrude into the bonding metal after reflow thereof.

9. The method of claim 8, wherein the first and second components are secured to one another by adhering to the reflowed bonding metal.

10. The method of claim 9, wherein the first and second components adhere to the bonding metal without the presence of flux during reflow of the bonding metal.

11. The method of claim 1, wherein the first or second component comprises an electronic component, an optical component, or an optoelectronic component.

12. The method of claim 1, wherein:
the first component comprises a planar optical waveguide substrate; and
the second component comprises a photodetector, an optical filter, a laser, an optical modulator, an optical amplifier, an optical reflector, an optical isolator, a lens, or a second planar optical waveguide substrate.

13. The method of claim 1, wherein:
the first component comprises a photodetector, an optical filter, a laser, an optical modulator, an optical amplifier, an optical reflector, an optical isolator, a lens, or a second planar optical waveguide substrate; and
the second component comprises a planar optical waveguide substrate.

14. An apparatus, comprising:
a first component having a bonding area, the bonding area having a plurality of bonding area projections formed thereon;
a second component having a bonding area corresponding to the bonding area of the first component; and
bonding metal deposited on the bonding area of the first component or the bonding area of the second component,
wherein:
the first and second components are positioned with the deposited bonding metal between their respective bonding areas and in contact therewith, and with the plurality of bonding area projections protruding into the deposited bonding metal; and
the first and second components are bonded to one another by adhering to the deposited bonding metal.

15. The apparatus of claim 14, wherein the respective bonding areas of the first and second components comprise conductive interconnection pads.

16. The apparatus of claim 14, wherein:
the bonding metal is deposited on the bonding area of the first component over the plurality of bonding area projections; and
the deposited bonding metal comprises a plurality of bonding metal projections protruding from the surface thereof, the bonding metal projections being formed above the plurality of bonding area projections upon deposition of the bonding metal thereon.

17. The apparatus of claim 16, wherein at least one bonding metal projection makes contact with the bonding area of the second component, and the bonding metal projection thus contacted is deformed by the contact.

18. The apparatus of claim 16, wherein:
bonding metal is also deposited on the bonding area of the second component; and
at least one bonding metal projection makes contact with the bonding metal deposited on the bonding area of the second component, and the bonding metal projection thus contacted is deformed by the contact.

19. The apparatus of claim 14, wherein the bonding metal is deposited on the bonding area of the second component, and the bonding area projections protrude into the bonding metal deposited on the bonding area of the second component.

20. The apparatus of claim 14, wherein the first and second components are bonded to one another by adhering to the deposited bonding metal without reflow of the bonding metal.

21. The apparatus of claim 14, wherein the bonding metal has been reflowed, and the plurality of bonding area projections protrude into the reflowed bonding metal.

22. The apparatus of claim 21, wherein the first and second components are bonded to one another by adhering to the reflowed bonding metal.

23. The apparatus of claim 22, wherein the first and second components adhere to the bonding metal without the presence of flux during reflow of the bonding metal.

24. The apparatus of claim 14, wherein the first or second component comprises an electronic component, an optical component, or an optoelectronic component.

25. The apparatus of claim 14, wherein:
the first component comprises a planar optical waveguide substrate; and
the second component comprises a photodetector, an optical filter, a laser, an optical modulator, an optical amplifier, an optical reflector, an optical isolator, a lens, or a second planar optical waveguide substrate.

26. The apparatus of claim 14, wherein:
the first component comprises a photodetector, an optical filter, a laser, an optical modulator, an optical amplifier, an optical reflector, an optical isolator, a lens, or a second planar optical waveguide substrate; and
the second component comprises a planar optical waveguide substrate.

27. A method for bonding first and second components to one another, comprising:
depositing bonding metal on a bonding area of the first component;
forming a plurality of bonding metal projections on the surface of the deposited bonding metal;
positioning the first component and the second component with the deposited bonding metal between respective bonding areas thereof; and
urging the first and second components toward one another, thereby pressing the deposited bonding metal therebetween,
wherein:
at least one bonding metal projection is deformed by the bonding metal being pressed between the first and second components; and
the first and second components are bonded to one another by each adhering to bonding metal.

28. The method of claim 27, wherein the respective bonding areas of the first and second components comprise conductive interconnection pads.

29. The method of claim 27, wherein at least one bonding metal projection makes contact, when the bonding metal is pressed between the first and second components, with the bonding area of the second component, and the bonding metal projection thus contacted is deformed by the bonding metal being pressed between the first and second components.

30. The method of claim 27, wherein:
additional bonding metal is deposited on the bonding area of the second component; and
at least one bonding metal projection makes contact, when the bonding metal is pressed between the first and second components, with the additional bonding metal deposited on the bonding area of the second component, and the bonding metal projection thus contacted is deformed by the bonding metal being pressed between the first and second components.

31. The method of claim 27, further comprising heating the bonding metal so that it reflows.

32. The method of claim 31, wherein the first and second components are bonded to one another by adhering to the reflowed bonding metal.

33. The method of claim 32, wherein the first and second components adhere to the bonding metal without the presence of flux during reflow of the bonding metal.

34. The method of claim 27, wherein the first or second component comprises an electronic component, an optical component, or an optoelectronic component.

35. The method of claim 27, wherein:
the first component comprises a planar optical waveguide substrate; and
the second component comprises a photodetector, an optical filter, a laser, an optical modulator, an optical amplifier, an optical reflector, an optical isolator, a lens, or a second planar optical waveguide substrate.

36. The method of claim 27, wherein:
the first component comprises a photodetector, an optical filter, a laser, an optical modulator, an optical amplifier, an optical reflector, an optical isolator, a lens, or a second planar optical waveguide substrate; and
the second component comprises a planar optical waveguide substrate.

37. An apparatus, comprising:
a first component having a bonding area;
a second component having a bonding area corresponding to the bonding area of the first component; and
bonding metal deposited on the bonding area of the first component with a plurality of bonding metal projections formed thereon,
wherein:
the first and second components are positioned with the deposited bonding metal between their respective bonding areas and in contact therewith, thereby deforming at least one bonding metal projection; and
the first and second components are bonded to one another by each adhering to the deposited bonding metal.

38. The apparatus of claim 37, wherein the respective bonding areas of the first and second components comprise conductive interconnection pads.

39. The apparatus of claim 37, wherein at least one bonding metal projection makes contact with the bonding area of the second component, and the bonding metal projection thus contacted is deformed by the bonding metal being pressed between the first and second components.

40. The apparatus of claim 37, wherein:
additional bonding metal is deposited on the bonding area of the second component; and
at least one bonding metal projection makes contact with the additional bonding metal deposited on the bonding area of the second component, and the bonding metal projection thus contacted is deformed by the bonding metal being pressed between the first and second components.

41. The apparatus of claim 37, wherein the first and second components are bonded to one another by adhering to the deposited bonding metal without reflow of the bonding metal.

42. The apparatus of claim 37, wherein the first or second component comprises an electronic component, an optical component, or an optoelectronic component.

43. The apparatus of claim 37, wherein:
the first component comprises a planar optical waveguide substrate; and
the second component comprises a photodetector, an optical filter, a laser, an optical modulator, an optical amplifier, an optical reflector, an optical isolator, a lens, or a second planar optical waveguide substrate.

44. The apparatus of claim 37, wherein:
the first component comprises a photodetector, an optical filter, a laser, an optical modulator, an optical amplifier, an optical reflector, an optical isolator, a lens, or a second planar optical waveguide substrate; and
the second component comprises a planar optical waveguide substrate.
